(19) United States
(12) Patent Application Publication
(10) Pub. No.: US 2016/0150085 A1
(43) Pub. Date: May 26, 2016

(54) SYSTEM AND METHOD FOR MANAGING ALLOCATION OF RESOURCES

(71) Applicant: Avaya Inc., Santa Clara, CA (US)

(72) Inventors: Tony McCormack, Galway (IE); Neil O'Connor, Galway (IE); Martin McDonnell, Co Clare (IE); Ciaran Agnew, Clare (IE)

(21) Appl. No.: 14/552,729

(22) Filed: Nov. 25, 2014

(51) Int. Cl. H04M 3/523

(52) U.S. Cl. CPC H04M 3/5232

(57) ABSTRACT

A computing system for managing a plurality of resources in an enterprise is disclosed. The computing system includes a monitoring one or more attributes of at least one communication session between at least one customer and at least one resource of the plurality of resources. The system further includes a database for storing the one or more monitored attributes. The system further includes a computing module for computing a contact time parameter for each of the at least one resource of the plurality of resources based on the one or more stored attributes. The system further includes an agent selection module for selecting at least one resource from the plurality of resources based on the computed contact time parameter. The system further includes a routing module for routing the at least one communication session to the at least one selected resource.

### BACKGROUND

1. Field

Embodiments of the present invention generally relate to a system and method to manage resources in an enterprise and particularly to a system and method for managing allocation of resources in an enterprise to handle communication sessions.

2. Description of Related Art

Contact centers are employed by many enterprises to service, inbound and outbound contacts or customers. A primary objective of contact center management is ultimately to maximize contact center performance and profitability. An ongoing challenge in contact center administration is monitoring and optimizing contact center efficiency usage of its available resources. Generally, the contact center efficiency is measured by metrics such as Service Level Agreement (SLA), Customer Satisfaction (CSAT), and match rate. Contact center resources may include, agents, communication assets (e.g., number of voice trunks, number and bandwidth of video trunks, etc.), computing resources (e.g., a speed, a queue length, a storage space, etc.), and so forth.

Service level is one measurement of the contact center efficiency. Service level is typically determined by dividing the number of contacts accepted within a specified period by the number accepted plus number that were not accepted, but completed in some other way (e.g., abandoned, given busy, canceled, flowed out). Service level definitions may vary from one enterprise to another.

Match rate is another indicator used in measuring the contact center efficiency. Match rate is usually determined by dividing the number of contacts accepted by a primary skill level agent within a period of time by the number of contacts accepted by any agent in a queue over the same period. An agent with a primary skill level is one who typically may handle contacts of a certain nature more effectively and/or efficiently as compared to an agent of lesser skill level. There are other contact center agents who may not be as proficient as the primary skill level agent, and those agents are identified as either skill level agents or backup skill level agents. As can be appreciated, contacts received by a primary skill level agent are typically handled more quickly and accurately or effectively (e.g., higher revenue attained) than a contact received by a secondary or even backup skill level agent. Thus, it is an objective of most contact centers to optimize match rate along with the service level.

In addition to service level and match rate performance measures, contact centers use other Key Performance Indicators (“KPIs”), such as revenue, estimated, actual, or predicted wait time, average speed of answer, throughput, agent utilization, agent performance, agent responsiveness and the like, to calculate performance relative to their Service Level Agreements (“SLAs”). Operational efficiency is achieved when the KPIs are managed near, but not above, SLA threshold levels.

Throughput is a measure of the number of contacts/contact requests or work requests that may be processed in a given amount of time. Agent utilization is a measure of how efficiently the agents' time is being used. Customer service level is a measure of the time customers spend waiting for their work to be handled. Contact center customers wish to provide service to as many requests as possible in a given amount of time, using the least number of agents to do so, and minimizing the wait time for their customers that may increase the Service Level Agreement (SLA) of the contact center. Further, the contact center may also have to maintain the Customer Satisfaction (CSAT) metrics in order to maintain the KPIs of the contact center. For this purpose, agents may have to maintain the quality of services provided to the customers through multimedia (e.g., voice contacts, video contacts, emails, etc.).

A primary objective of a contact center is to manage its resources in order to maximize the contact center efficiency. Generally, the contact center manages its resources by using predefined strategies, for example, Resource Selection Strategies (RSS), and/or Work Selection Strategies (WSS). The Resource Selection Strategies are generally used when there are surplus of resources available within the contact center, whereas, the Work Selection Strategies are used when there are surplus of incoming contacts or communication sessions. Conventionally, when Resource Selection Strategies are used, incoming contacts are assigned to resources such as agents of the contact center, based on predefined set of rules. These predefined algorithms match the attributes of the resources with characteristics of the incoming contacts and then select a resource based on the matching. For example, an agent whose attributes match best with characteristics of an incoming contact is selected to provide customer service to the incoming contact. However, there may be a possibility that the selected agent is busy in handling another contact of the contact center.

Further, conventional techniques do not provide information, such as Predicted Contact Time (PCT), i.e., time required by a resource of the contact center to complete a communication session of an incoming contact, to a contact center operator of the contact center. This information can be useful for the contact center operator in order to manage time and/or allocation of the resources within the contact center. However, conventional techniques lack in providing some specific control to the contact center operator in selecting resources for incoming contacts based on the information of how long a specific resource is expected to take on a given incoming contact. This may further result in large inefficiencies in long work time situations. Furthermore, conventional techniques do not provide capability to prioritize selection of resources based on the information.

There is thus a need for a system and method for managing resources within an enterprise.

### SUMMARY

Embodiments in accordance with the present invention provide a computing system for managing a plurality of resources in an enterprise. The computing system includes a monitoring module for monitoring one or more attributes of at least one communication session between at least one customer and at least one resource of the plurality of resources. The system further includes a database for storing the one or more monitored attributes. The system further includes a computing module for computing a contact time parameter for each of the at least one resource of the plurality of resources based on the one or more stored attributes. The system further includes an agent selection module for selecting at least one resource from the plurality of resources based on the computed contact time parameter. The system further includes a routing module for routing the at least one communication session to the at least one selected resource.

Embodiments in accordance with the present invention further provide a computer-implemented method for managing a plurality of resources in an enterprise. The method includes monitoring one or more attributes of at least one communication session between at least one customer and at least one resource of the plurality of resources; storing the one or more monitored attributes in at least one database; computing a contact time parameter for each of the at least one resource of the plurality of resources based on the one or more stored attributes; selecting at least one resource from the plurality of resources based on the computed contact time parameter; and routing the at least one communication session to the at least one selected resource.

Embodiments in accordance with the present invention further provide a computer-implemented method for selecting at least one resource for at least one communication session in an enterprise. The method includes monitoring one or more attributes of the at least one communication session between at least one customer and the at least one resource of a plurality of resources; storing the one or more monitored attributes in at least one database; computing a contact time parameter for each of the at least one resource of the plurality of resources based on the one or more stored attributes; selecting the at least one resource from the plurality of resources based on the computed contact time parameter, wherein the at least one resource is selected by ranking the computed contact time parameter; and routing the at least one communication session to the at least one selected resource to provide customer service.

Embodiments of the present invention may provide a number of advantages depending on its particular configuration. First, embodiments of the present application provide a system and a method for managing a plurality of resources in an enterprise, such as, but not limited to, a contact center. Embodiments of the present application provide a computing system that manages time and/or allocation of the plurality of the resources in the enterprise. The present invention computes a contact time parameter for each of available resources in the enterprise, which defines an amount of time a resource may take to provide services to a customer associated with a communication session.

Next, embodiments of the present application enables an operator of the enterprise to gain more control over time of resources by dynamically controlling duration of communication sessions assigned to them. For example, a supervisor may route a communication session of a customer that may take a more time, for example, 15 minutes, to complete the communication session and a second communication session that may take a less time, such as two minutes, to complete the second communication session.

These and other advantages will be apparent from the present application of the embodiments described herein.

The preceding is a simplified summary to provide an understanding of some embodiments of the present invention. This summary is neither an extensive nor an exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a block diagram depicting a contact center, according to an embodiment of the present invention;

FIG. 1B illustrates a high level hardware abstraction of a block diagram of a server, according to an embodiment of the present invention;

FIG. 2 illustrates a functional block diagram of the server that may be used in the contact center, according to an embodiment of the present invention;

FIG. 3 depicts a flowchart of a method for managing resources in the contact center, according to an embodiment of the present invention; and

FIG. 4 depicts a flowchart of a method for selecting a resource for a communication session in the contact center, according to another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention will be illustrated below in conjunction with an exemplary communication system, e.g., the Avaya Aura® system. Although well suited for use with, e.g., a system having an Automatic Call Distribution (ACD) or other similar contact-processing switch, embodiments of the present invention are not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, a paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

The terms “customer” and “contact” may be used interchangeably in certain context of this disclosure of the present invention when referring to one or more persons/entity contacting a contact center, usually to reach an IVR system and/or one or more agents for assistance. In another context contemplated by the present invention, a “customer” may have more than one contact with the contact center at, or nearly at, the same time. For example, a customer may communicate with a contact center by way of telephone and by way of a chat, thus counting as one customer but two contacts.

The terms “agent” and “resource” may be used interchangeably in certain context of this disclosure of the present invention when referring to one or more persons/entity servicing a contact in a contact center or a knowledge resource within an enterprise servicing back office transactions.

A digital file attachment to e-mail or other self-contained information archive or set of archives is considered a distribution medium equivalent to a tangible storage medium. When the computer-readable media is configured as a database, it is to be understood the database may be any type of database, such as relational, hierarchical, object-oriented, and/or the like. Accordingly, embodiments may include a tangible storage medium or distribution medium and prior art-recognized equivalents and successor media, in which the software embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a Private Branch Exchange (PBX), an ACD, an enterprise switch, or other type of communications system switch or server, as well as other types of processor-based communication control devices such as media servers, computers, adjuncts, etc.

The term “resource” may be used interchangeably in certain context with “agent” within this disclosure of the present invention when referring to one or more persons/entity servicing a contact in a contact center or a knowledge resource within an enterprise servicing back office transactions. In an embodiment of the present invention, the resource may be, but is not restricted to, an agent, an available agent, a reserve agent, a trainee agent, a Subject Matter Expert (SME), a supervisor, and so forth.

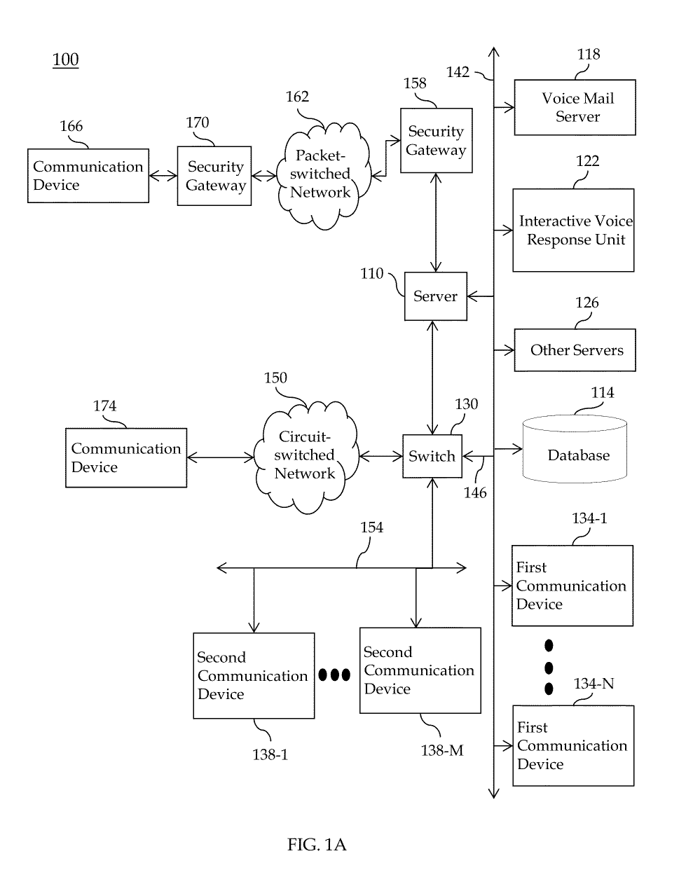

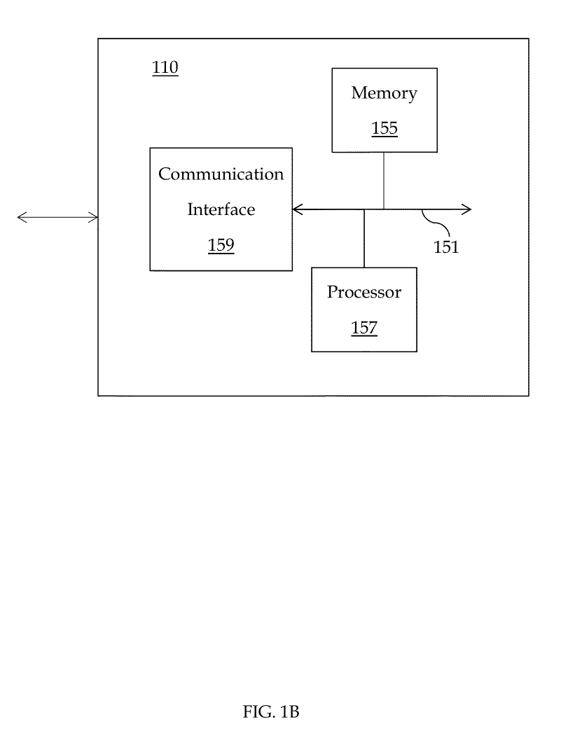

FIG. 1A shows an illustrative embodiment of the present invention. A contact center 100 comprises a server 110, a set of data stores or databases 114 containing contact or customer related information, resource or agent related information, and other information that may enhance the value and efficiency of the contact processing. The contact center 100 further comprises a plurality of servers, namely a voice mail server 118, an Interactive Voice Response unit (e.g., IVR) 122, and other servers 126, a switch 130, a plurality of working agents operating packet-switched (first) communication devices 134-1-N (such as computer work stations or personal computers), and/or circuit-switched (second) communication devices 138-1-M, all interconnected by a Local Area Network (LAN) 142, (or Wide Area Network (WAN)). In another embodiment of the present invention, the customer and agent related information may be replicated over multiple repositories.

The plurality of servers may be connected via optional communication lines 146 to the switch 130. As will be appreciated, the other servers 126 may also include, but is not restricted to, a scanner (which is normally not connected to the switch 130 or Web Server), VoIP software, video call software, voice messaging software, an IP voice server, a fax server, a web server, an email server, and the like. The switch 130 is connected via a plurality of trunks to a circuit-switched network 150 (e.g., Public Switch Telephone Network (PSTN)) and via link(s) 154 to the second communication devices 138-1-M. A security gateway 158 is positioned between the server 110 and a packet-switched network 162 to process communications passing between the server 110 and the packet-switched network 162. In an embodiment of the present invention, the security gateway 158 (as shown in FIG. 1A) may be Avaya Inc.'s, G700 Media Gateway™ and may be implemented as hardware such as via an adjunct processor (as shown) or as a chip in the server 110.

The switch 130 and/or server 110 may be any architecture for directing incoming contacts to one or more communication devices. In some embodiments of the present invention, the switch 130 may perform load-balancing functions by allocating incoming or outgoing contacts among a plurality of logically and/or geographically distinct contact centers. Illustratively, the switch 130 and/or server 110 may be a modified form of subscriber-premises equipment sold by Avaya Inc. under the names Definity™ Private-Branch Exchange (PBX) based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya, or another company. Typically, the switch 130/server 110 is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide ACD functionality. Other types of known switches and servers are well known in the art and therefore not described in detail herein.

The first communication devices 134-1-N are packet-switched and may include, for example, IP hardphones such as the Avaya Inc.'s, 4600 Series IP Phones™, IP softphones such as Avaya Inc.'s, IP Softphone™, Personal Digital Assistants (PDAs), Personal Computers (PCs), laptops, packet-based H.320 video phones and conferencing units, packet-based voice messaging and response units, packet-based traditional computer telephony adjuncts, peer-to-peer based communication devices, and any other communication device.

The second communication devices 138-1-M are circuit-switched devices. Each of the second communication devices 138-1-M corresponds to one of a set of internal extensions Ext-1-M, respectively. The second communication devices 138-1-M may include, for example, wired and wireless telephones, PDAs, H.320 videophones and conferencing units, voice messaging and response units, traditional computer telephony adjuncts, and any other communication devices.

It should be noted that embodiments of the present invention do not require any particular type of information transport medium between switch, or server and first and second communication devices, i.e., the embodiments of the present invention may be implemented with any desired type of transport medium as well as combinations of different types of transport channels.

The packet-switched network 162 may be any data and/or distributed processing network, such as the Internet. The packet-switched network 162 typically includes proxies (not shown), registrars (not shown), and routers (not shown) for managing packet flows.

The packet-switched network 162 as shown in FIG. 1A is in communication with a first communication device 166 via a security gateway 170, and the circuit-switched network 150 with an external second communication device 174.

In one configuration, the server 110, the packet-switched network 162, and the first communication devices 134-1-N are Session Initiation Protocol (SIP) compatible and may include interfaces for various other protocols such as the Lightweight Directory Access Protocol (LDAP), H.248, H.323, Simple Mail Transfer Protocol (SMTP), Internet Message Access Protocol 4 (IMAP4), Integrated Services Digital Network (ISDN), E1/T1, and analog line or trunk.

It should be emphasized the configuration of the switch 130, the server 110, user communication devices, and other elements as shown in FIG. 1A is for purposes of illustration only and should not be construed as limiting embodiments of the present invention to any particular arrangement of elements.

Further, the server 110 is notified via the LAN 142 of an incoming contact by the communications component (e.g., switch 130, a fax server, an email server, a web server, and/or other servers) receiving the incoming contact as shown in FIG. 1A. The incoming contact is held by the receiving telecommunications component until the server 110 forwards instructions to the component to forward or route the incoming contact to a specific contact center resource, such as the IVR unit 122, the voice mail server 118, and/or first or second telecommunication device 134-1-N, 138-1-M associated with a selected agent.

FIG. 1B illustrates at a relatively high-level hardware abstraction of a block diagram of a server such as the server 110, in accordance with an embodiment of the present invention. The server 110 may include an internal communication interface 151 that interconnects a processor 157, a memory 155 and a communication interface circuit 159. The communication interface circuit 159 may include a receiver and transmitter (not shown) to communicate with other elements of the contact center 100 such as the switch 130, the security gateway 158, the LAN 142, and so forth. By use of programming code and data stored in the memory 155, the processor 157 may be programmed to carry out various functions of the server 110.

Although embodiments of the present invention are discussed with reference to client-server architecture, it is to be understood the principles of embodiments of the present invention may also apply to other network architectures. For example, embodiments of the present invention may apply to peer-to-peer networks, such as those envisioned by the Session Initiation Protocol (SIP). In the client-server model or paradigm, network services and the programs used by end users to access the services are described. The client side provides a customer with a communication interface for requesting services from the network, and the server side is responsible for accepting customer requests for services and providing the services transparent to the customer. By contrast in the peer-to-peer model or paradigm, each networked host runs both the client and server parts of an application program. Additionally, embodiments of the present invention do not require the presence of packet- or circuit-switched networks.

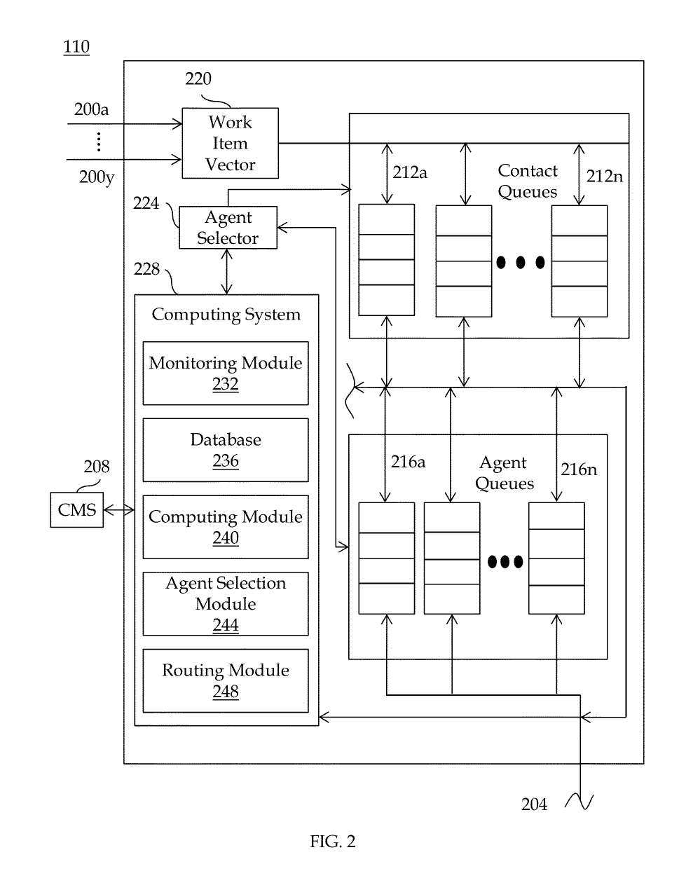

Referring to FIG. 2, one possible configuration of the server 110 is depicted at a relatively high level of functional abstraction, according to an embodiment of the present invention. The server 110 is in communication with a plurality of contact or customer communication lines 200a-y (which may be one or more trunks, phone lines, etc.) and an agent communication line 204 (which may be a voice-and-data transmission line such as the LAN 142 and/or a circuit switched voice line). The server 110 may include Avaya Inc.'s Operational Analyst™ (OA) with On-Line Analytical Processing (OLAP) technology or a Call Management System (CMS) 208 that gathers contact records. OA and CMS will hereinafter be referred to jointly as CMS 208.

As shown in FIG. 2, among the data stored in the server 110 is a set of contact or work item queues 212a-n and a separate set of agent queues 216a-n. Each contact queue 212a-n corresponds to a different set of agent queues, as does each agent queue 216a-n. Conventionally, incoming contacts either are prioritized or are queued in individual ones of the contact queues 212a-n in their order of priority or are queued in different ones of a plurality of contact queues that correspond to a different priority. Likewise, each agent's queues are prioritized according to his or her level of expertise or skill in that queue, and agents are queued in either individual ones of agent queues 216a-n in their order of expertise level or in different ones of a plurality of agent queues 216a-n that correspond to a queue and each one of which corresponds to a different expertise level. In an embodiment of the present invention, the agent queue 216a-n may include a set of reserve agents queue in the contact center 100.

According to an embodiment of the present invention, included among the control programs in the server 110 is a work item vector 220. Contacts incoming to the contact center 100 are assigned by the work item vector 220 to different contact queues 212a-n based upon a number of predetermined criteria, including, but are not limited to, a customer's identity, customer needs, contact center needs, current contact center queue lengths, a customer value, and an agent skill that is required for proper handling of the contact. Agents who are available for handling work items are assigned to the agent queues 216a-n based upon the skills and/or attributes that they possess. An agent may have multiple skills and/or attributes, and therefore may be assigned to multiple agent queues 216a-n simultaneously. Furthermore, an agent may have different levels of skill expertise (e.g., skill levels 1-N in one configuration or merely primary skill levels and secondary skill levels in another configuration), and therefore may be assigned to different agent queues 216a-n at different expertise levels.

In one configuration, the contact center 100 is operated by a contact center operator (e.g., a supervisor or a manager of the contact center 100), and each of the contact queues 212a-n, and possibly each of the agent queues 216a-n, corresponds to a different client. Each client may have a separate Service Level Agreement (SLA) or other type of performance measurement agreement with the contact center operator regarding performance expectations, business goals, requirements or specifications for the client's respective queue(s).

Further, embodiments in accordance with the present invention may include, among the programs executing on the server 110, an agent selector 224 and a computing system 228. The agent selector 224 and the computing system 228 are stored either in the main memory or in a peripheral memory (e.g., disk, CD ROM, etc.) or some other computer-readable medium of the contact center 100. Further, the agent selector 224 monitors the occupants of the contact and agent queues 212a-n and 216a-n, respectively, and contact center objectives, goals, rules, and policies and assigns agents to service incoming contacts.

The agent selector 224 distributes and connects these contacts to communication devices of available agents based on the predetermined criteria noted above. When the agent selector 224 forwards a contact (or first work item) to an agent, the agent selector 224 also forwards customer-related information from the database 114 to the agent's desktop or computer work station for previewing and/or viewing (such as by a pop-up display) to enable the agent for providing better services to the contact. Depending on the contact center configuration, the agent selector 224 may reallocate the contacts to the agents of the contact center 100. The agents' process the contacts sent to them by the agent selector 224.

In an embodiment of the present invention, the agent and their associated data are maintained and updated in the database 114 of the contact center 100. Upon the completion of handling an incoming contact, a generator (not shown) collects selected metrics for the contact. These metrics may include, but is not restricted to, skills involved in servicing the contact, an identifier of a servicing agent, contact duration, a transaction or contact type (e.g., sale, information request, complaint, etc.), time-of-day, result of the contact (e.g., type of sale, number of units sold, an average revenue generated, etc.), and so forth. The metrics along with other statistics is typically gathered by the CMS 208.

According to an embodiment of the present invention, the computing system 228 includes certain modules, such as, but is not restricted to, a monitoring module 232, a database 236, a computing module 240, an agent selection module 244, and a routing module 248. In some embodiments of the present invention, one or more of the monitoring module 232, the database 236, the computing module 240, the agent selection module 244, and the routing module 248 may be implemented by one or more software processes running on the server 110. In an embodiment of the present invention, the database 236 may be the database 114. The database 236 may be stored outside the computing system 228, in another embodiment of the present invention. The server 110 may implement one or more software processes by use of the processor 157 being suitably programmed by use of software instructions stored in the memory 155 coupled to the processor 157.

The monitoring module 232 may monitor attributes of a communication session, according to an embodiment of the present invention. The monitoring module 232 may monitor a type of the communication session, according to an embodiment of the present invention. The type of the communication session, i.e., whether the communication session made by a customer, is but is not restricted to, a video session, a voice session, a Voice over Internet Protocol (VoIP), a text message, an email, an instant messaging, a web chat, and so forth. The communication session may be an incoming contact or a communication session, in an embodiment of the present invention.

Further, the monitoring module 232 may monitor a type of the customer associated with the communication session, according to an embodiment of the present invention. In an exemplary scenario, a customer may be, but is not restricted to, a platinum customer or a high priority customer, a gold customer or a medium priority customer, and/or a silver customer or a low priority customer. A customer having higher revenue products and/or services of the contact center 100 may be considered as a high priority customer. A customer having medium revenue products and/or services of the contact center 100 may be considered as a medium priority customer. Further, a customer having low revenue products and/or services or is a potential customer of the contact center 100 may be considered as a low priority customer. In an embodiment of the present invention, the monitoring module 232 may gather the type of the customers from the database 236.

The monitoring module 232 may further monitor static details about the communication session, for example, a customer selects inputs in an IVR menu of the contact center 100. In an exemplary scenario, if a customer selects a button ‘7’ for a ‘laptop’ in an IVR menu, selects a button ‘2’ for ‘English’ language, and further selects a button ‘1’ for an ‘inquiry’, then it is determined that the customer desires to inquire about a laptop in English language. Further, the monitoring module 232 may monitor context of the communication session, according to an embodiment of the present invention. The monitoring module 232 may monitor the context of the communication session by monitoring browsing history of the customer, in an embodiment of the present invention. For example, the customer is searching for a laptop from past 25 minutes on a web page associated with the contact center 100. In another embodiment of the present invention, the monitoring module 232 may monitor the context of the communication session by monitoring communication history of the customer with the contact center 100.

Furthermore, the monitoring module 232 may monitor sentiments of the customer and/or a resource associated with the communication session, in an embodiment of the present invention. The sentiment may include, but is not restricted to, a positive sentiment, a negative sentiment, a neutral sentiment, and so forth. The positive sentiment may indicate that the customer is happy and satisfy from customer services provided by the contact center 100. Examples of the positive sentiment may be, but is not restricted to, fulfilled, glad, optimistic, and so forth. The negative sentiment may indicate that the customer is unhappy and unsatisfied from customer services provided by the contact center 100. Examples of the negative sentiment may be, but is not restricted to, frustrated, angry, irritated, and so forth. The neutral sentiment may indicate that the customer is not fully satisfied or happy but is not fully unsatisfied or unhappy from the customer services provided by the contact center 100. In an embodiment of the present invention, the monitoring module 232 may detect sentiments of the customer and/or the resource from start of the communication session to an end of the communication session. For example, sentiments of a customer at the start of a communication session may be happy but deteriorates as the communication session proceeds. The monitoring module 232 may also detect the sentiments of the customer and/or a resource in non-voice communication sessions, for example, text messages, emails, instant messages, web chats, and so forth.

The monitoring module 232 may monitor attributes of each of resources of the contact center 100, according to an embodiment of the present invention. The attributes of a resource may include, but not restricted to, a type of a resource, i.e., whether a resource is a highly skilled, or a low skilled resource, work experience of a resource, technical training, education and work histories, communication sessions allocated to a resource, skill set of a resource, behavioral data of a resource, demographic data of a resource, and so forth.

As user herein, the term “skill set” refers to a set of resource data that may be used by the contact center 100 to characterize a resource. Such resource data may include, but is not limited to, biographical resource data, demographic resource data, and external or internal behavioral resource data, to name a few. The behavioral data may include the resource's history with respect to the contact center 100 and/or any other entity or social media channel. However, the resource data is not limited in this regard and may include any other type of resource data used by the contact center 100 to characterize or classify resources. Further, the resource data may include any other resource data collected from one or more sources external to the contact center 100. Additionally, a resource profile may be raw data or processed resource data. That is, the resource data may be analyzed to characterize the resource and thereafter used to provide customized or personalized services to the customer. For example, a resource profile may be a set of values associated with a resource and a set of characteristics, where the values may be selected based on the resource data obtained. However, the disclosure is not limited in this regard and any other methods for evaluating resource data to provide services that may be used without limitation.

In an embodiment of the present invention, the monitoring module 232 may monitor the attributes of the communication session from an ongoing communication session in a real-time environment. In another embodiment of the present invention, the monitoring module 232 may monitor and/or gather attributes of the communication session from historical data and/or browsing history of customers stored in a database such as the database 114, or the database 236. Attributes of a communication session may include, but are not restricted to, a type of a communication session, a type of a customer, static details of a communication session, sentiments of a resource and/or customer, attributes of resources, or a combination thereof, in an embodiment of the present invention. The monitored attributes of the communication session are then stored in the database such as the database 114, or the database 236, in an embodiment of the present invention.

Furthermore, the monitoring module 232 may extract keywords from the monitored and/or stored attributes of the communication session, according to an embodiment of the present invention. In an exemplary scenario, the customer provides information by selecting inputs in an IVR menu that the customer desires to interact with a resource proficient in providing services associated with laptops, their inquiry who speaks ‘English’, then ‘laptop’, ‘inquiry’, and ‘English’ may be extracted as keywords for the communication session. In another exemplary scenario, the monitoring module 232 may analyze text and extract keywords from a textual communication session such as an instant messaging, a text message, an email, a web chat, and so forth. Next, if the type of the communication session is a voice session, then the monitoring module 232 may convert speech of the customer and/or the resource into text by using a voice recognition module (not shown), which is then monitored to extract keywords for the communication session.

The database 236 may also store the keywords extracted from the communication session, in an embodiment of the present invention. Further, the database 236 may store browsing history of the customers on web pages associated with the contact center 100. In an embodiment of the present invention, the monitored attributes and/or other data may be replicated over multiple repositories. In another embodiment of the present invention, the database 236 may provide the stored attributes to the monitoring module 232.

The computing module 240 may compute a contact time parameter for each of a resource of a plurality of resources of the contact center 100, according to an embodiment of the present invention. The contact time parameter may be, but is not restricted to, a Predicted Contact Time (PCT) of the communication session, in an embodiment of the present invention. In an embodiment of the present invention, PCT may be considered as a predicted contact time each resource may take to close and/or complete a communication session with a customer of the contact center 100.

In another embodiment of the present invention, PCT may also be considered as a predicted contact time a communication session may take based on a predefined set of rules, which may include multiple factors, for example, but are not limited to, product complexity, a tone of communication session, time of day of communication session, day of communication session, and so forth. In an embodiment of the present invention, the predefined set of rules may be defined by the contact center 100.

The computing module 240 may compute the contact time parameter for each of a resource of a plurality of resources based on the stored attributes, according to an embodiment of the present invention. In an embodiment of the present invention, resources may be resources that are available to handle a communication session. In an exemplary scenario, stored keywords of a communications session are ‘laptop’, ‘inquiry’, ‘English’, and there are four resources available in the contact center 100, then the computing module 240 may compute a contact time parameter for each of the available resources, for example, computed contact time parameter for resource ‘A’ may be five minutes, for resource ‘B’ may be 4 minutes 30 seconds, for resource ‘C’ may be seven minutes, and for resource ‘D’ may be ten minutes.

Further, the computing module 240 may calculate a score for each of the available resources based on the computed contact time parameter, according to an embodiment of the present invention. In an embodiment of the present invention, the score for each of the available resources is computed by using a set of predefined rules. In an embodiment of the present invention, the predefined set of rules may be stored in the database such as the database 114, or the database 236. Further, the computing module 240 may then rank the computed contact time parameters of the available resources based on the calculated score, business goals, or a combination thereof. In an embodiment of the present invention, the business goal may include, but is not limited to, a business strategy that is used in order to improve efficiency of the contact center 100. In an exemplary scenario, the business strategy may include, but are not limited to, a resource selection strategy, a work selection strategy, or a combination thereof.

In an exemplary scenario, if there are two resources available in a laptop division of the contact center 100 to handle a communication session, then a contact time parameter for a trainee resource may be calculated as ‘15 minutes’ and for a highly skilled agent resource may be calculated as ‘5 minutes’. Then based on a resource selection strategy of the contact center 100, the trainee resource may be ranked as ‘1’ and the highly skilled agent resource may be ranked as ‘2’, as the contact center 100 do not desire to engage a highly skilled agent in the communication session.

In another exemplary scenario, if computed contact time parameter is 3 minutes and a high priority customer is associated with a communication session, then a Subject Matter Expert (SME) may be ranked ‘1’ for the communication session. In yet another exemplary scenario, the resource selection strategy may select a resource with a highest computed contact time parameter specific to a communication session, while a profile of a customer prefers a resource having a verbose conversation style. Further, the computing module 240 may rank the computed contact time parameters of the available resources based on various factors, for example, but are not limited to, highest idle time, shortest idle time, and so forth.

The agent selection module 244 may select a resource based on the computed contact time parameters of the available resources of the contact center 100, according to an embodiment of the present invention. The agent selection module 244 may select a resource for the communication session based on the ranking of the computed contact time for each of the available resources, in another embodiment of the present invention. The selected resource may be, but is not restricted to, a supervisor, an agent, a reserve agent, a Subject Matter Expert (SME), to name a few. The agent selection module 244 may select a highly skilled resource that may handle the communication session in a shortest amount of time, in an embodiment of the present invention. In another embodiment of the present invention, the agent selection module 244 may select a resource of a lower profile such as a trainee for a communication session whose computed contact time parameter is a high value, for example, 15 minutes as the contact center 100 does not desire to engage a highly skilled agent in the communication session.

In an embodiment of the present invention, the agent selection module 244 may automatically select an agent based on the computed, ranked, or a combination thereof, contact time parameters. In another embodiment of the present invention, the agent selection module 244 may enable a supervisor of the contact center 100 to select a resource manually based on the computed, ranked, or a combination thereof, contact time parameters. In an exemplary scenario, the supervisor of the contact center 100 may manage time of a resource by allocating communication sessions having long and/or short computed contact time parameters. Therefore, the supervisor of the contact center 100 may be able to manage distribution of communication sessions, time of a resource, or a combination thereof, based on factors, for example, but are not limited to, a length of a communication session, a duration of time spend on a communication session, and so forth.

The routing module 248 may route the communication session to the selected resource, according to an embodiment of the present invention. The communication session is routed to the selected resource to provide customer service.

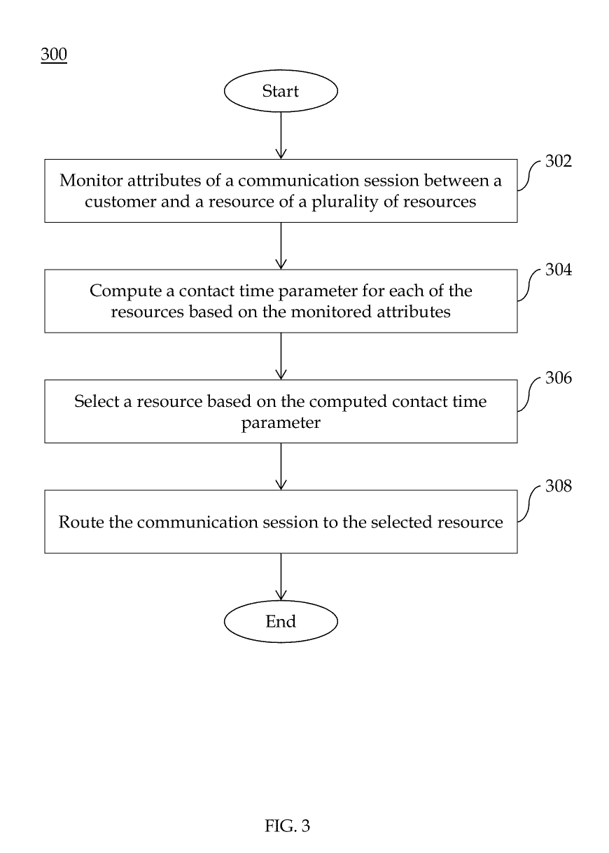

FIG. 3 depicts a flowchart of a method 300 for managing a plurality of resources in the contact center 100, according to an embodiment of the present invention.

At step 302, a computing system 228 monitors attributes of a communication session between a customer and a resource of the plurality of resources of the contact center 100, according to an embodiment of the present invention. The computing system 228 monitors a type of the communication session to the contact center 100, in an embodiment of the present invention. The type of the communication session, i.e., whether the communication session made by the customer is, but is not restricted to, a video session, a voice session, a Voice over Internet Protocol (VoIP), a text message, an email, an instant messaging, a web chat, and so forth. The computing system 228 further monitors static details about the communication session, for example, a customer selects inputs in an IVR menu of the contact center 100. Further, the computing system 228 monitors context of the communication session, according to an embodiment of the present invention by monitoring browsing history of the customer, in an embodiment of the present invention.

Further, the computing system 228 monitors a type of the customer associated with the communication session, according to an embodiment of the present invention. In an exemplary scenario, a customer may be, but is not restricted to, a high priority customer, a medium priority customer, or a low priority customer. In an embodiment of the present invention, the computing system 228 gathers information about the type of the customer from the database 236, or the database 114. Furthermore, the computing system 228 monitors sentiment of the customer and/or resource associated with the communication session, in an embodiment of the present invention. The sentiment may include, but is not restricted to, a positive sentiment, a negative sentiment, a neutral sentiment, and so forth. In an embodiment of the present invention, the computing system 228 detects sentiments of a customer from start of the communication session to an end of the communication session. The computing system 228 also detects the sentiments in non-voice communication sessions, for example, text messages, emails, instant messages, web chats, and so forth.

The computing system 228 further monitors attributes of each of resources of the contact center 100, according to an embodiment of the present invention. The attributes of a resource may include, but not restricted to, a type of a resource, i.e., whether a resource is a highly skilled, or a low skilled resource, work experience of a resource, technical training, education and work histories, communication sessions allocated to a resource, skill set of a resource, behavioral data of a resource, demographic data of a resource, and so forth.

In an embodiment of the present invention, attributes of a communication session may include, but are not restricted to, a type of a communication session, a type of a customer, static details of a communication session, sentiments of a customer, attributes of resources, or a combination thereof. In an embodiment of the present invention, the computing system 228 monitors attributes of the communication session from an ongoing communication session in a real-time environment. In another embodiment of the present invention, the computing system 228 monitors and/or gather attributes of the communication session from historical data and/or browsing history stored in a database such as the database 114 or the database 236. Further, the computing system 228 extracts keywords from the monitored attributes of the communication session, according to an embodiment of the present invention.

At step 304, the computing system 228 computes a contact time parameter for each of the resource of the plurality of resources based on the monitored attributes, according to an embodiment of the present invention. In an exemplary scenario, stored keywords of a communications session are ‘mobile phone’, ‘inquiry’, ‘French’, and there are three resources available in the contact center 100, then the computing system 228 computes a contact time parameter for each of the available resources, for example, computed contact time parameter for resource ‘A’ may be two minutes, for resource ‘B’ may be ‘three minutes’, and for resource ‘C’ may be seven minutes.

Further, the computing system 228 calculates a score for each of the available resources based on the computed contact time parameter, according to an embodiment of the present invention. In an embodiment of the present invention, the available resources are scored by using predefined set of rules. Further, the computing system 228 then ranks the computed contact time parameters of the available resources based on the calculated score, business goals, or a combination thereof. In an embodiment of the present invention, the business goal may include, but is not limited to, a business strategy of the contact center 100.

In an exemplary scenario, the business strategy may include, but is not limited to, a resource selection strategy, a work selection strategy, or a combination thereof. In an exemplary scenario, if a resource is a highly skilled agent in a car insurance policy division then a communication session whose computed contact time parameter is 1 minute then based on a resource selection strategy, the highly skilled agent is ranked ‘1’. Further, the computing system 228 ranks the computed contact time parameters of the available resources based on various factors, but are not limited to, highest idle time, shortest idle time, and so forth.

Next, at step 306, the computing system 228 selects a resource based on the computed contact time parameters of the available resources of the contact center 100, according to an embodiment of the present invention. The computing system 228 selects a resource for the communication session based on the ranking of the computed contact time parameters for each of the available resources, in another embodiment of the present invention. The selected resource may be, but is not restricted to, a supervisor, an agent, a reserve agent, a Subject Matter Expert (SME), to name a few. The computing system 228 selects a highly skilled resource that may handle the communication session in a shortest amount of time, in an embodiment of the present invention.

In an embodiment of the present invention, the computing system 228 automatically select an agent based on the computed, ranked, or a combination thereof, contact time parameters. In another embodiment of the present invention, the computing system 228 enables a supervisor of the contact center 100 to select a resource manually based on the computed, ranked, or a combination thereof contact time parameters. In an exemplary scenario, the supervisor of the contact center 100 may manage time of a resource by allocating communication sessions having long and/or short computed contact time parameters.

At step 308, the computing system 228 routes the communication session to the resource selected in the step 306, according to an embodiment of the present invention. The communication session is routed to the selected resource to provide customer service.

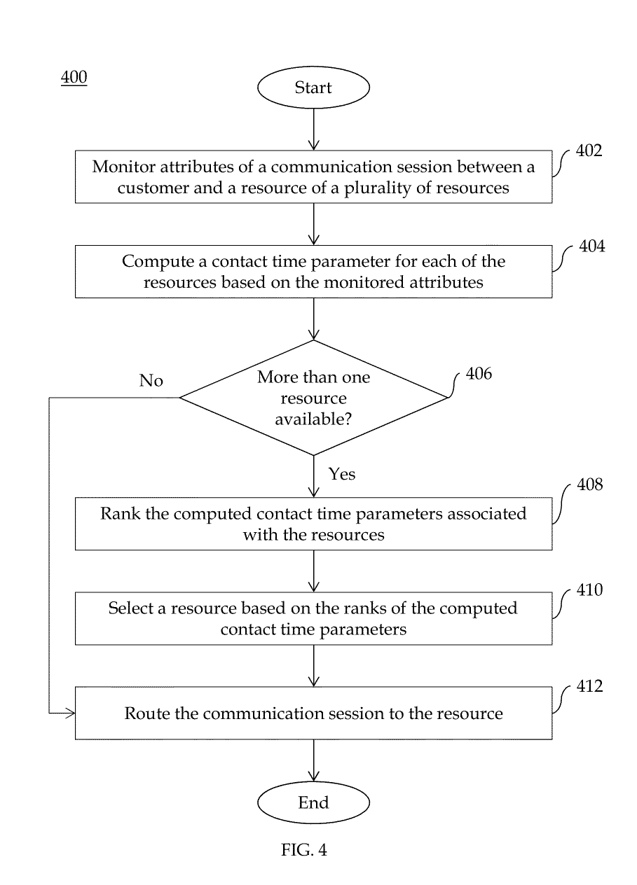

FIG. 4 depicts a flowchart of a method 400 for selecting a resource for a communication session in the contact center 100, according to another embodiment of the present invention.

At step 402, a computing system 228 monitors attributes of a communication session between a customer and a resource of a plurality of resources of the contact center 100, according to an embodiment of the present invention. The computing system 228 monitors a type of the communication session to the contact center 100, in to an embodiment of the present invention. The type of the communication session, i.e., whether the communication session made by a customer is, but is not restricted to, a video session, a voice session, a Voice over Internet Protocol (VoIP), a text message, an email, an instant messaging, a web chat, and so forth. Further, the computing system 228 monitors a type of the customer associated with the communication session, according to an embodiment of the present invention. In an exemplary scenario, a customer may be, but is not restricted to, a high priority customer, a medium priority customer, or a low priority customer. In an embodiment of the present invention, the computing system 228 gathers the type of the customer from the database 236. Furthermore, the computing system 228 monitors sentiments of the customer and/or a resource during the communication session, in an embodiment of the present invention. The sentiment may include, but is not restricted to, a positive sentiment, a negative sentiment, a neutral sentiment, and so forth. In an embodiment of the present invention, the computing system 228 detects sentiments of a customer and/or resource from start of the communication session to an end of the communication session. The computing system 228 also detects the sentiments in non-voice communication sessions, for example, text messages, emails, instant messages, web chats, and so forth.

Further, the computing system 228 monitors static details about the communication session, for example, inputs selected by the customer in an IVR menu of the contact center 100. Further, the computing system 228 monitors context of the communication session, according to an embodiment of the present invention. In an exemplary scenario, the context of the communication session is monitored by monitoring browsing history of the customer.

The computing system 228 further monitors attributes of each of resources of the contact center 100, according to an embodiment of the present invention. The attributes of a resource may include, but not restricted to, a type of a resource, i.e., whether a resource is a highly skilled, or a low skilled resource, work experience of a resource, technical training, education and work histories, communication sessions allocated to a resource, skill set of a resource, behavioral data of a resource, demographic data of a resource, and so forth.

In an embodiment of the present invention, attributes of a communication session may include, but are not restricted to, a type of a communication session, a type of a customer, static details of a communication session, sentiments of a customer, attributes of resources, or a combination thereof. In an embodiment of the present invention, the computing system 228 monitors attributes of the communication session from an ongoing communication session in a real-time environment. Further, the computing system 228 extracts keywords from the monitored attributes of the communication session, according to an embodiment of the present invention.

At step 404, the computing system 228 computes a contact time parameter for each of the resource of the plurality of resources based on the monitored attributes, according to an embodiment of the present invention. In an exemplary scenario, stored keywords of a communications session are ‘mobile phone’, ‘sale’, ‘French’, and there are five resources available in the contact center 100, then a contact time parameter for each of available resources is computed, for example, computed contact time parameter for resource ‘A’ may be one minute, for resource ‘B’ may be two minutes, for resource ‘C’ may be eight minutes, for resource ‘D’ may be seven minutes, and for resource ‘E’ may be five minutes.

Next, at step 406, the computing system 228 determines whether more than one resource is available for handling the communication session, according to an embodiment of the present invention. If it is determined that more than one resource is available for handling the communication session, the method 400 proceeds towards step 408. If it is determined that only one resource is available in the contact center 100 for the communication session, then the method 400 proceeds towards step 412.

Next, at step 408, the computing system 228 calculates a score for each of the available resources of the plurality of resources based on the computed contact time parameter, according to an embodiment of the present invention. In an embodiment of the present invention, the available resources are scored by using predefined set of rules. Further, the computing system 228 ranks the computed contact time parameters of the available resources based on the calculated score, business goals, or a combination thereof.

Thereafter, at step 410, the computing system 228 selects a resource based on the ranks of the contact time parameters of the available resources, according to an embodiment of the present invention. The selected resource may be, but is not restricted to, a supervisor, an agent, a reserve agent, a Subject Matter Expert (SME), to name a few. The computing system 228 selects a highly skilled resource that may handle the communication session in a shortest amount of time based on the business strategy, in an embodiment of the present invention. In an exemplary scenario, the computing system 228 selects a resource of a lower profile, for example, a trainee, for the communication session having high value of the computed contact time parameter such as ten minutes as the contact center 100 does not desire to engage a highly skilled agent in the communication session.

In an embodiment of the present invention, the computing system 228 automatically select an agent based on the computed, ranked, or a combination thereof, contact time parameters. In another embodiment of the present invention, the computing system 228 enables a supervisor of the contact center 100 to select a resource manually based on the computed, ranked, or a combination thereof, contact time parameters for each of the available resources. In an exemplary scenario, the supervisor of the contact center 100 may manage time of a resource by allocating communication sessions having long and/or short computed contact time parameters for available resources. Therefore, the supervisor of the contact center 100 may manage distribution of communication sessions, time of a resource, or a combination thereof, based on various factors such as but is not limited to, a length of a communication session, a duration of time spend on a communication session, and so forth.

At step 412, the computing system 228 routes the communication session to the resource selected in the step 410, according to an embodiment of the present invention. If more than one resource is available in the contact center 100, then the communication session is routed to the selected resource. In an embodiment of the present invention, if only one resource is available in the contact center 100, then the communication session is routed to the available resource to provide customer service.

The exemplary embodiments of this present invention have been described in relation to a contact center. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, changes, additions, and omissions to this sequence can occur without materially affecting the operation of embodiments of the present invention.

A number of variations and modifications of the present invention can be used. It would be possible to provide for some features of the present invention without providing others.

For example in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with embodiments of the present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, it is not limited to such standards and protocols. Other similar standards and protocols not mentioned herein are in existence and considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A computing system for managing a plurality of resources in an enterprise, the system comprising:
a processor;
a computer-readable medium coupled to the processor, the medium comprising one or more computer readable instructions, the processor executing the one of more computer readable instructions to:
monitor attributes of at least one communication session between at least one customer and at least one resource of the plurality of resources;
store the monitored attributes in a database;
compute a contact time parameter for the each of the at least one resource of the plurality of resources based on the stored monitored attributes;
select a resource from the plurality of resources based on the computed contact time parameter; and
route a communication session for an incoming contact to the selected resource.

2. The system of claim 1, wherein the processor further extracts at least one keyword from the at least one communication session.

3. The system of claim 2, wherein the extracted keyword is stored in the database.

4. The system of claim 1, wherein the processor further calculates a score for each of the resource of the plurality of resources based on the computed contact time parameter.

5. The system of claim 1, wherein the processor further ranks the computed contact time parameter based on the calculated score.

6. The system of claim 5, wherein the contact time parameter for each of the plurality of resources is ranked based on at least one business strategy.

7. The system of claim 5, wherein the processor further selects the at least one resource based on the ranks of each of the computed contact time parameters associated with the plurality of the resources.

8. The system of claim 1, wherein the processor further enables a supervisor to manually select the at least one resource from the plurality of resources.

9. The system of claim 1, wherein the at least one resource is one of a reserve agent, an agent, a supervisor, or a Subject Matter Expert (SME).

10. A computer-implemented method for managing a plurality of resources in an enterprise, the method comprising:
monitoring, by a processor, one or more attributes of at least one communication session between at least one customer and at least one resource of the plurality of resources;
storing, by the processor, the one or more monitored attributes in at least one database;
computing, by the processor, a contact time parameter for each of the at least one resource of the plurality of resources based on the one or more stored monitored attributes;
selecting, by the processor, a resource from the plurality of resources based on the computed contact time parameter; and
routing, by the processor, a communication session for an incoming contact to the selected resource.

11. The method of claim 10, wherein the processor further extracts at least one keyword from the at least one communication session.

12. The method of claim 11, further stores the extracted keyword in the at least one database.

13. The method of claim 10, wherein the processor further calculates a score for each of the resource of the plurality of resources based on the computed contact time parameter.

14. The method of claim 10, wherein the processor further ranks the computed contact time parameter based on the calculated score.

15. The method of claim 14, wherein the processor further selects the at least one resource based on the rank of each of the computed contact time parameters.

16. The method of claim 10, wherein the processor further enables a supervisor to manually select the at least one resource from the plurality of resources.

17. The method of claim 10, wherein the at least one resource is one of a reserve agent, an agent, a supervisor, or a Subject Matter Expert (SME).

18. A computer-implemented method for selecting at least one resource for at least one communication session in an enterprise, the method comprising:
monitoring, by a processor, one or more attributes of the at least one communication session between at least one customer and the at least one resource of a plurality of resources;
storing, by the processor, the one or more monitored attributes in at least one database;
computing, by the processor, a contact time parameter for each of the at least one resource of the plurality of resources based on the one or more stored monitored attributes;
selecting, by the processor, at least one resource from the plurality of resources based on the computed contact time parameter, wherein the at least one resource is selected by ranking the computed contact time parameter; and
routing, by the processor, at least one communication session for an incoming contact to the at least one selected resource to provide customer service.

19. The method of claim 18, wherein the processor further calculates a score for each of the resource of the plurality of resources based on the computed contact time parameter.

20. The method of claim 18, wherein the at least one resource is one of a reserve agent, an agent, a supervisor, or a Subject Matter Expert (SME).
